(19) United States
(12) Patent Application Publication
(10) Pub. No.: US 2021/0348389 A1
(43) Pub. Date: Nov. 11, 2021

(54) Corrosion Prevention Method and Corrosion Prevention Device

(71) Applicant: Nippon Telegraph and Telephone Corporation, Tokyo (JP)

(72) Inventors: Yosuke Takeuchi, Musashino-shi, Tokyo (JP); Takuya Kamisho, Musashino-shi, Tokyo (JP); Masayuki Tsuda, Musashino-shi, Tokyo (JP)

(21) Appl. No.: 17/274,724

(22) PCT Filed: Sep. 12, 2019
(86) PCT No.: PCT/JP2019/035923

§ 371 Date: Mar. 9, 2021

(30) Foreign Application Priority Data
Sep. 26, 2018 (JP) 2018-179704

(51) Int. Cl. E04C 5/01; E04G 23/02

(52) U.S. Cl. CPC E04C 5/015; C04B 20/1066; E04G 23/02

(57) ABSTRACT

Reinforced concrete is easily repaired at a low cost. An anti-corrosion method for preventing corrosion of a reinforcing bar inside reinforced concrete includes: an impregnation step of impregnating with water a cracked portion having occurred in the reinforced concrete, and a drying step of removing the water from the cracked portion and forming an anti-corrosive coating on the surface of the reinforcing bar. The anti-corrosive coating is formed by the neutralization of an alkali component by the drying step, the alkali component having been leached from concrete in the cracked portion by the impregnation step.

### TECHNICAL FIELD

The present invention relates to an anti-corrosion method and an anti-corrosion apparatus for reinforced concrete.

### BACKGROUND ART

Aging degradation of a large number of reinforced concrete structures constructed during the high economic growth period has been concerned. As a restoration and repair technique for concrete structures, there is a method for cross-section restoration (Non-Patent Literatures 1 and 2). In this method, the repair is performed by using a concrete machine tool to remove a degraded portion and lay a sound concrete repairing material.

There is also an electrochemical restoration and repair method (Non-Patent Literatures 1 and 3). This is a technique that applies a large current to an existing degraded concrete structure by using an electrochemical device for a short period of time to desalinate and repair the structure by an electrochemical method.

### CITATION LIST

### Non-Patent Literature

Non-Patent Literature 1: “Salt damage, neutralization, and method for repair and reinforcement”, written by Kono and one other person, Concrete Journal, vol. 31, No. 7, July 1993, pp. 65 to 68

Non-Patent Literature 2: “Experimental study on corrosion formation in section restoration portion of reinforced concrete member”, written by Nagataki and three others, Journal of Japan Society of Civil Engineers (JSCE), No. 544/vol. 32, August 1996, pp. 109 to 119

Non-Patent Literature 3: “Basic study on desalination and re-alkalization technique for reinforced concrete member”, written by Otsuki and three others, Journal of JSCE, No. 520/vol. 28, August 1995, pp. 67 to 76

### SUMMARY OF THE INVENTION

### Technical Problem

In the prior art, there is a problem of high repair cost because a special and large machine, such as a concrete machine tool or an electrochemical device, is required in repairing reinforced concrete and a complicated process, such as excavation of degraded concrete, is performed.

The present invention has been made in view of the above problem, and an object of the present invention is to easily repair reinforced concrete at a low cost without using a special machine such as a concrete machine tool or an electrochemical device.

### Means for Solving the Problem

In order to achieve the above object, the present invention is an anti-corrosion method for preventing corrosion of a reinforcing bar inside reinforced concrete, the method including: an impregnation step of impregnating with water a cracked portion that occurs in the reinforced concrete, and a drying step of removing the water from the cracked portion and forming an anti-corrosive coating on a surface of the reinforcing bar. The anti-corrosive coating is formed by neutralization of an alkali component by the drying step, the alkaline component being leached from concrete in the cracked portion by the impregnation step.

The present invention is an anti-corrosion apparatus for preventing corrosion of a reinforcing bar inside reinforced concrete, the apparatus including: a water supply unit that impregnates with water a cracked portion that occurs in the reinforced concrete; a drying unit that removes the water from the cracked portion and forms an anti-corrosive coating on a surface of the reinforcing bar; and a control unit that controls the water supply unit and the drying unit. The anti-corrosive coating is formed by neutralization of an alkali component by the removal of the water, the alkaline component being leached from concrete in the cracked portion by the impregnation of the water.

### Effects of the Invention

According to the present invention, the reinforced concrete can be easily repaired at a low cost.

### BRIEF DESCRIPTION OF DRAWINGS

FIG. 1 is a diagram showing an overall configuration of an anti-corrosion apparatus according to an embodiment of the present invention.

FIG. 2 is a flowchart showing anti-corrosion processing.

FIG. 3 is a diagram showing a change in pH with time and changes in charge transfer resistance value with time in cases with and without an anti-corrosive coating.

### DESCRIPTION OF EMBODIMENTS

Embodiments of the present invention will be described below with reference to the drawings.

Reinforced concrete protects reinforcing bars on its inside from corrosion by covering the reinforcing bars with alkaline concrete, in addition to the reinforcing bars on its inside enhancing the strength of the concrete. The reinforcing bars in sound reinforced concrete without cracks are passivated since being covered by the alkaline environment of the concrete. However, in cracked reinforced concrete, the neutralization progresses inside the concrete in a cracked part to cause de-passivation, and the corrosion of the reinforcing bar progresses.

In the anti-corrosion technique of the present embodiment, when cracking occurs on the surface (exposed surface) of a reinforced concrete structure such as a building, a cracked part (hereinafter, “cracked portion”) is impregnated with water to promote the leaching of an alkali component in the concrete and an anti-corrosive coating, generated due to neutralization associated with the subsequent drying step, is formed on the surface of a reinforcing bar disposed inside the cracked portion.

Thus, in the present embodiment, it is unnecessary to perform restoration and repair work for concrete by using a large device such as an electrochemical device or a concrete machine tool for cutting the concrete. Therefore, the present embodiment is a useful technique as an emergency measure when a crack is detected in inspection work for a reinforced concrete structure.

The present embodiment is to perform anti-corrosion on the surface of the reinforcing bar in the reinforced concrete by using the anti-corrosive coating, thereby requiring that the effect of a saline matter which destroys the anti-corrosive coating has been removed. Hence a determination is made as to whether the installation environment of the reinforced concrete structure is an area of a salt-damaged environment, and the present embodiment is applied when the installation environment is not the salt-damaged environment. In the case of the salt-damaged environment, combination with desalination and re-alkali by an electrochemical method is possible, but because the combination requires a large device or the like, reinforced concrete structure in such an environment should be excluded from the anti-corrosion target of the present embodiment.

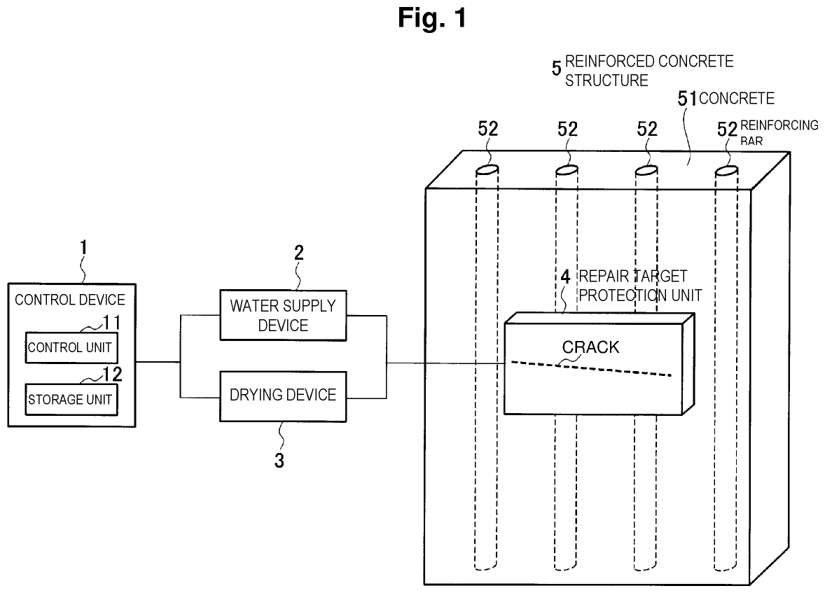

FIG. 1 is a diagram showing a configuration of an anti-corrosion apparatus (system) of the present embodiment. The anti-corrosion apparatus prevents corrosion of reinforcing bars inside reinforced concrete. The illustrated anti-corrosion apparatus includes a control device 1 (control unit), a water supply device 2 (water supply unit), a drying device 3 (drying unit), and a repair target protection unit 4.

The control device 1 is connected to the water supply device 2 and the drying device 3 electrically, physically, or via a network. The illustrated control device 1 includes a control unit 11 and a storage unit 12. As the control device 1, for example, a computer such as a personal computer is used.

The control unit 11 controls the water supply device 2 and the drying device 3. Specifically, the control unit 11 transmits a control signal to the water supply device 2 to control the water supply device 2, thereby performing an impregnation step of supplying water to a cracked portion of a reinforced concrete structure 5 (reinforced concrete). The control unit 11 transmits a control signal to the drying device 3 to control the drying device 3, thereby performing a drying step of removing the water in the cracked portion and drying the cracked portion. The control unit 11 controls the water supply device 2 and the drying device 3 so as to alternately repeat the impregnation step and the drying step. The control unit 11 controls (modifies, adjusts) the time for the impregnation step and the time for the drying step in accordance with the type of water with which the impregnation is performed.

The storage unit 12 stores an arbitrary number of repetitions set in advance for repeating the impregnation step and the drying step. The storage unit 12 stores the time for the impregnation step and the time for the drying step respectively in accordance with the type of water with which the impregnation is performed.

The water supply device 2 impregnates with water the cracked portion having occurred in the reinforced concrete structure 5 in accordance with the control of the control device 1. The drying device 3 removes the water from the cracked portion in accordance with the control of the control device 1 and forms an anti-corrosive coating on the surface of a reinforcing bar 52 disposed inside the cracked portion. The anti-corrosive coating is formed by the neutralization of an alkali component by the removal of the water, the alkali component having been leached from concrete 51 in the cracked portion by the impregnation of the water.

The repair target protection unit 4 forms a closed space for protecting the cracked portion from an external environment. Specifically, the repair target protection unit 4 is structured to be firmly attached to the reinforced concrete structure 5 by using a gasket or the like, blocks the cracked portion from the external environment, and is formed to have a closed space except for the connection to the water supply device 2 and the drying device 3.

In the illustrated reinforced concrete structure 5, a plurality of reinforcing bars 52 are disposed inside the concrete 51. The surface of the reinforced concrete structure 5 has the cracked portion where a crack (cracking) causing the progress of corrosion of the reinforcing bar 52 has occurred.

Next, anti-corrosion processing of the present embodiment will be described.

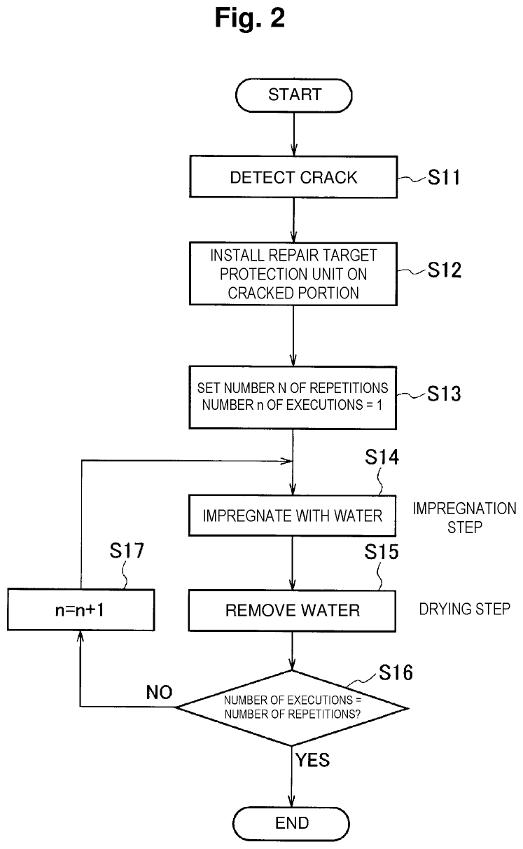

FIG. 2 is a diagram showing an example of a processing flow of the anti-corrosion processing. In the present embodiment, as described above, the reinforced concrete structure installed in the salt-damaged environment is excluded from a target for the anti-corrosion processing of the present embodiment.

First, a user detects a crack having occurred in the reinforced concrete structure by visual inspection, an inspection technique using a camera or the like (S11).

Then, the user installs the repair target protection unit 4, configured to protect the detected cracked portion (repair target) from the external environment, at the position of the cracked portion of the reinforced concrete structure (S12). The repair target protection unit 4 is structured to be firmly attached to the reinforced concrete structure by using a gasket or the like and is installed so as to cover the cracked portion. The repair target protection unit 4 blocks the cracked portion from the external environment and is formed to have a closed space except for the connection with the water supply device 2 and the drying device 3.

Then, the control device 1 sets a number N of repetitions of the impregnation step of impregnating water and the subsequent drying step of forming and fixing the anti-corrosive coating (S13). As the number of repetitions, the number of repetitions stored in advance into the storage unit 12 may be used, or the number of repetitions input into the control device 1 by the user may be used. The control device 1 sets an initial value “1” for a number n of executions.

The number of repetitions is one or more. The anti-corrosiveness is enhanced when the number of executions of the impregnation step and the drying step is set to more than one, but even when the number of executions is set to one (N=1), the anti-corrosiveness can be provided to the reinforcing bar. After the number of repetitions is set, the control device 1 shifts to the impregnation step in S14.

In the impregnation step, the control device 1 controls the water supply device 2 so as to impregnate the cracked portion of the reinforced concrete structure, detected in S11, with water (S14). By the impregnation with the water, an alkali component in the concrete is leached. Specifically, the control device 1 transmits a control signal for instructing water supply to the water supply device 2. Thereby, the water supply device 2 supplies water to the repair target protection unit 4 and impregnates the cracked portion protected by the repair target protection unit 4 with water. The water supply device 2 supplies water until the inside of the repair target protection unit 4 is filled with the water.

As the water, a chlorine-free solution is used. For example, pure water or an aqueous solution of calcium hydroxide, which is a main component of concrete, may be used as the water. It is difficult to adjust the concentration of the aqueous solution of calcium hydroxide, and hence a saturated solution of calcium hydroxide may be used.

When the aqueous solution of calcium hydroxide is used, the concrete in the cracked portion is alkalinized in the impregnation step, and the aqueous solution of calcium hydroxide contacts and reacts with carbon dioxide in the air in the drying step, thereby forming the anti-corrosive coating of calcium carbonate in a short time, which is more effective.

The control device 1 maintains a state where the cracked portion is impregnated with water for a predetermined time, and shifts to the drying step after the lapse of the predetermined time.

In the drying step, the control device 1 removes the water, with which the inside of the cracked portion has been impregnated, and dries the cracked portion (S15). Thereby, the alkali component leached in the impregnation step is neutralized to form the anti-corrosive coating which does not exist at the time of occurrence of cracking, and the anti-corrosive coating is fixedly formed so as to cover the surface of the reinforcing bar. This leads to the expression of anti-corrosive performance.

Specifically, the control device 1 controls the water supply device 2 by transmitting a control signal for instructing water discharge to the water supply device and discharges the water having filled the repair target protection unit 4. Thereafter, the control device 1 controls the drying device 3 by transmitting a drying instruction to the drying device 3 so as to dry the inside of the repair target protection unit 4.

Hence the water supply device 2 discharges water from the repair target protection unit 4. The drying device 3 blows dry air or warm air into the closed space of the repair target protection unit 4, or heats the reinforcing bar by electromagnetic induction heating, to dry the cracked portion of the concrete.

The control device 1 may change and adjust the time for the impregnation step and the time for the drying step in accordance with the type of water with which the impregnation is performed. For example, when pure water is used as the water, the alkali component needs to be eluted inside the cracked portion, so that it is desirable to cause the drying to proceed slowly in a relatively long time by natural drying, the delivery of dry air, or some other means. When the aqueous solution of calcium hydroxide is used as the water, the drying may be performed in a relatively short time by, for example, the blowing of warm air from the drying device 3, the heating of the reinforcing bar by electromagnetic induction heating, or some other means, to accelerate the drying step.

The control device 1 makes the cracked portion dry for a predetermined time and shifts to the next step after the lapse of the predetermined time.

As the time for the impregnation step and the time for the drying step, the respective times stored in advance into the storage unit 12 may be used, or the times input into the control device 1 by the user at the time of setting the number of repetitions in S13 may be used. It is desirable that the respective times (predetermined times) for the impregnation step and the drying step be investigated in advance using a test specimen simulating the reinforced concrete structure of an investigation target and be stored into the storage unit 12.

After the impregnation step and the drying step are performed, the control device 1 compares the number n of executions with the number N of repetitions to make a determination (S16). When the number n of executions is smaller than the number N of repetitions (n<N), the control device 1 adds 1 to the number n of executions and returns to the impregnation step of S14 (S17). When the number n of executions is equal to the number N of repetitions (n≥N), the control device 1 ends the processing. It is desirable to alternately repeat the impregnation step and the drying step because the surface of the reinforcing bar inside the cracked portion may not be sufficiently covered with the anti-corrosive coating in one-time impregnation step and drying step.

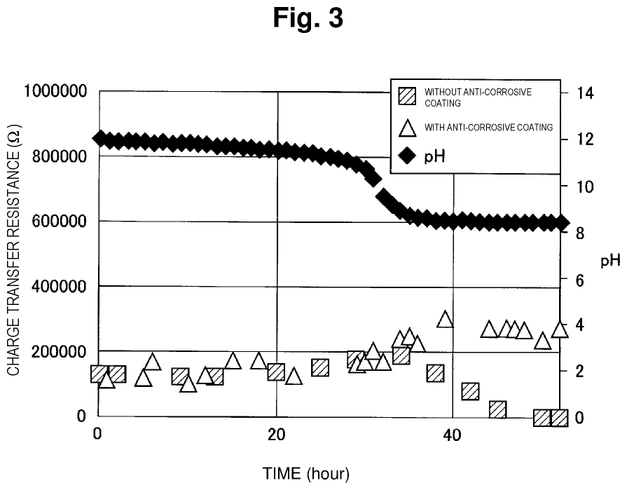

FIG. 3 shows changes in charge transfer resistance when a steel material with an anti-corrosive coating, formed by using a saturated aqueous solution of calcium hydroxide and performing the impregnation step and the drying step described above once each, and a steel material without the anti-corrosive coating are installed in an alkaline environment, and then the environment is becoming neutralized. SS400 was used for each of the steel materials.

When the pH of the steel material without the anti-corrosive coating decreases to about 10, the charge transfer resistance starts to decrease. The decrease in charge transfer resistance means the progress of corrosion, and it can thus be considered that the corrosion of the steel material has progressed with the neutralization of the environment.

On the other hand, the pH of the steel material with the anti-corrosive coating decreased to about 10, and the charge transfer resistance did not decrease even when the neutralization of the environment progresses. It is thus obvious that the reinforcing bar inside the cracked portion can be protected from corrosion by the anti-corrosive coating formed in the impregnation step and the drying step described above.

In the anti-corrosion method of the present embodiment described above, the impregnation step of impregnating with water a cracked portion having occurred in the reinforced concrete and the drying step of removing the water from the cracked portion and forming an anti-corrosive coating on the surface of the reinforcing bar are performed, and the anti-corrosive coating is formed by the neutralization of an alkali component by the drying step, the alkali component having been leached from concrete in the cracked portion by the impregnation step.

As a result, in the present embodiment, the corrosion of the reinforcing bars in the reinforced concrete can be prevented, and the reinforced concrete can be easily repaired at a low cost. That is, conventionally, a large device such as a concrete machine tool or an electrochemical device has been required for repairing a cracked portion of a reinforced concrete structure, and a complicated process such as removal of concrete has been required, but in the present embodiment, the effect of anti-corrosion can be applied to the reinforcing bar inside the crack by the simple method of impregnation with and drying of water, to perform the repair of the reinforced concrete structure. Therefore, in the present embodiment, the anti-corrosion and repair of the reinforced concrete structure can be performed more easily and inexpensively than in the conventional case. The present embodiment is a technique also useful as an emergency measure when a crack is detected in inspection work for a reinforced concrete structure.

Further, in the present embodiment, the repair target protection unit 4 for protecting the cracked portion of the reinforced concrete is used. It is thereby possible to remove disturbances, such as neutralization of concrete and destruction of the coating due to acid rain and a decrease in efficiency in the drying step due to an increase in atmospheric humidity, and effectively advance the impregnation step and the drying step. The water discharge can be performed quickly by filling the repair target protection unit 4 with water at the time of impregnation with water and then dehydrating the repair target protection unit 4. At the time of drying, the drying can be performed quickly by blowing or heating dry air or warm air in a closed space.

As the control device 1 described above, there can be used a general-purpose computer system including, for example, a central processing unit (CPU) (processor), a memory, storage (hard disk drive (HDD), solid-state drive (SSD)), a communication device, an input device, and an output device. In the computer system, each function of the control device 1 is realized by the CPU executing a program for the control device 1 loaded onto the memory. The program for the control device 1 can be stored into a computer-readable recording medium such as an HDD, an SSD, a universal serial bus (USB) memory, a compact disc read-only memory (CD-ROM), a digital versatile disc (DVD)-ROM, or a magneto-optical disc (MO), or the program can be distributed via a network.

The present invention is not limited to the above embodiment, and various modifications can be made within the scope of the present invention.

### REFERENCE SIGNS LIST

1 Control device
11 Control unit
12 Storage unit
2 Water supply device
3 Drying device
4 Repair target protection unit
5 Reinforced Concrete Structure
51 Concrete
52 Reinforcing bar

1. An anti-corrosion method for preventing corrosion of a reinforcing bar inside reinforced concrete, the method comprising:
an impregnation step of impregnating with water a cracked portion that occurs in the reinforced concrete, and
a drying step of removing the water from the cracked portion and forming an anti-corrosive coating on a surface of the reinforcing bar,
wherein the anti-corrosive coating is formed by neutralization of an alkali component by the drying step, the alkaline component being leached from concrete in the cracked portion by the impregnation step.

2. The anti-corrosion method according to claim 1, wherein the impregnation step and the drying step are repeated alternately.

3. The anti-corrosion method according to claim 1, wherein the water contains no chlorine.

4. The anti-corrosion method according to claim 1, wherein the water is pure water or an aqueous solution of calcium hydroxide.

5. The anti-corrosion method according to claim 4, wherein a time for the drying step is varied between when the water is the pure water and when the water is the aqueous solution of calcium hydroxide.

6. The anti-corrosion method according to claim 1, wherein in the drying step, a temperature of the reinforcing bar is raised by electromagnetic induction heating to remove the water.

7. An anti-corrosion apparatus for preventing corrosion of a reinforcing bar inside reinforced concrete, the apparatus comprising:
a water supply unit that impregnates with water a cracked portion that occurs in the reinforced concrete;
a drying unit that removes the water from the cracked portion and forms an anti-corrosive coating on a surface of the reinforcing bar; and
a control unit that controls the water supply unit and the drying unit,
wherein the anti-corrosive coating is formed by neutralization of an alkali component by the removal of the water, the alkaline component being leached from concrete in the cracked portion by the impregnation of the water.

8. The anti-corrosion apparatus according to claim 7, further comprising a repair target protection unit that forms a closed space for protecting the cracked portion from an external environment.

9. The anti-corrosion method according to claim 2, wherein the water contains no chlorine.

10. The anti-corrosion method according to claim 2, wherein the water is pure water or an aqueous solution of calcium hydroxide.

11. The anti-corrosion method according to claim 3, wherein the water is pure water or an aqueous solution of calcium hydroxide.

12. The anti-corrosion method according to claim 2, wherein in the drying step, a temperature of the reinforcing bar is raised by electromagnetic induction heating to remove the water.

13. The anti-corrosion method according to claim 3, wherein in the drying step, a temperature of the reinforcing bar is raised by electromagnetic induction heating to remove the water.

14. The anti-corrosion method according to claim 4, wherein in the drying step, a temperature of the reinforcing bar is raised by electromagnetic induction heating to remove the water.

15. The anti-corrosion method according to claim 5, wherein in the drying step, a temperature of the reinforcing bar is raised by electromagnetic induction heating to remove the water.
